(19) United States
(12) Patent Application Publication
(10) Pub. No.: US 2014/0185989 A1
(43) Pub. Date: Jul. 3, 2014

(54) Connector, Cabling And Signaling For Communication Protocols

(71) Applicant: BROADCOM CORPORATION, Irvine, CA (US)

(72) Inventors: William Calvin Woodruff, Pleasanton, CA (US); Chung Ming Tu, Irvine, CA (US)

(73) Assignee: Broadcom Corporation, Irvine, CA (US)

(21) Appl. No.: 13/785,875

(22) Filed: Mar. 5, 2013

Related U.S. Application Data
(60) Provisional application No. 61/748,178, filed on Jan. 2, 2013.
(60) Provisional application No. 61/770,864, filed on Feb. 28, 2013.

(51) Int. Cl. H01R 13/66; G02B 6/36

(52) U.S. Cl. CPC H01R 13/6608; G02B 6/36
USPC 385/77; 439/620.21; 439/660

(57) ABSTRACT

A connector includes a connector interface. A cable housing covers the connector interface and a cable connects with the connector interface. A passive component is positioned within the cable housing, the passive component being connected with the connector interface and the cable.

### PRIORITY CLAIM

This application claims priority to U.S. Provisional Application Ser. No. 61/748,178, filed Jan. 2, 2013 and U.S. Provisional Application Ser. No. 61/770,864, filed Feb. 28, 2013, which are incorporated herein by reference in their entirety.

### TECHNICAL FIELD

This disclosure relates to connectors, cabling and signaling for communication protocols, and more particularly communication protocols for consumer electronics.

### BACKGROUND

Communication protocols are widely used in local area networks (LAN). For example, Ethernet as specified in the Institute of Electrical and Electronics Engineers (IEEE) 802.3 standard is one such technology. The Ethernet includes a physical and data link layer technology for the LAN. An Ethernet LAN can use coaxial cable or special grades of twisted pair wires, and is also used in wireless LANs. Ethernet systems include 10BASE-T which provides transmission speeds up to 10 megabits per second (Mbps).

Devices are connected to the cable and can access the Ethernet using a Carrier Sense Multiple Access with Collision Detection (CSMA/CD) protocol. Fast Ethernet or 100BASE-T can provide transmission speeds up to 100 Mbps and can be used for LAN backbone systems, supporting workstations with 10BASE-T cards. Gigabit Ethernet provides an even higher level of backbone support at 1000 megabits per second (1 gigabit or 1 billion bits per second). 10-Gigabit Ethernet can provide up to 10 billion bits per second. An RJ45 connector can be used with Ethernet cables and networks. RJ45 connectors feature eight pins to which the wire strands of a cable interface electrically.

### BRIEF DESCRIPTION OF THE DRAWINGS

The innovation may be better understood with reference to the following drawings and description. In the figures, like reference numerals can designate corresponding parts throughout the different views.

FIG. 1 shows an example of user equipment connected with the Ethernet via an exemplary connector.

FIG. 2 is a front view of a plug end of an exemplary connector.

FIG. 3 is a side view of the plug end of the exemplary connector.

FIG. 4 is perspective view of an exemplary receptacle end of the connector.

FIG. 5 is a side view of the receptacle end of the connector.

FIG. 6 is a circuit diagram of the connector using exemplary AC coupling.

FIG. 7 is a circuit diagram of the connector using exemplary transformer coupling.

FIG. 8 is a circuit diagram of an exemplary PHY for a new 10 G protocol.

FIG. 9 is a circuit diagram of an exemplary PHY for a display interface.

### DETAILED DESCRIPTION

The discussion below makes reference to a connector for connecting user equipment, e.g., consumer electronics, via a communication protocol that can include Ethernet. An advantage of the connector can include the ability to provide Ethernet or other protocol type networking in markets that do not currently include such interconnects. For example, a size of the RJ45 type connector may not fit a low profile user equipment, e.g., tablets, ultra-notebooks and mobile phones, e.g., smartphones. In one example, the connector can enable the use of Ethernet in small form factor devices by allowing placement of coupling elements outside the user equipment and by enabling the use of small, low cost capacitive coupling outside the user equipment. In another example, a signaling can operate over the connector that can support legacy BASE-T. The signaling can provide a next generation 10 Gigabit Ethernet (GE) option in consumer electronics without cabling constraints and include a low power/low latency 10 GE option in enterprise/data centers where it may stand alone or exist in conjunction with 10GBASE-T.

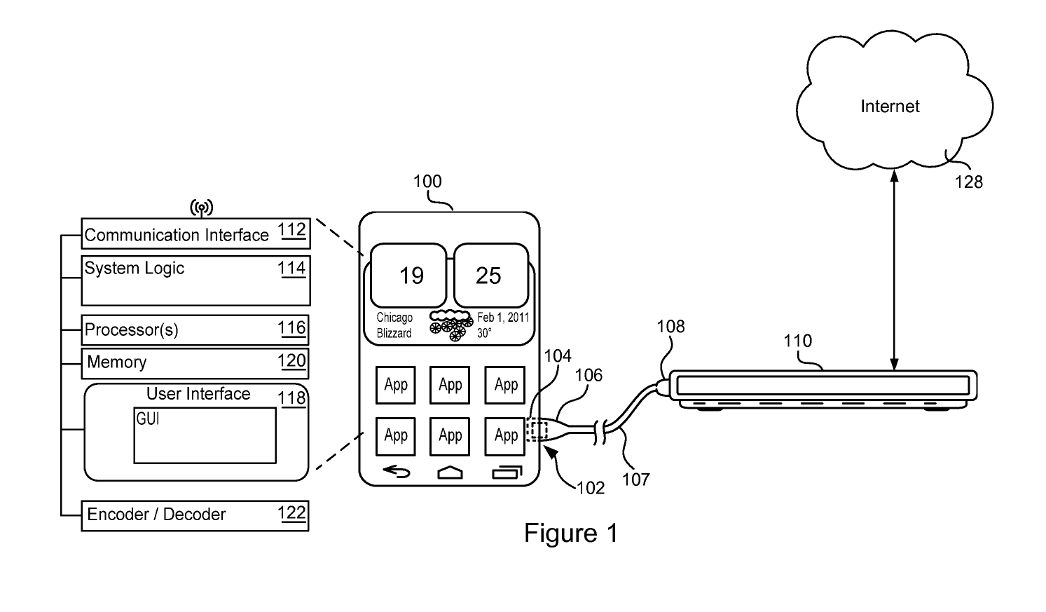

FIG. 1 shows an example of user equipment 100 connected with a communication protocol via an exemplary connector 102. An electrical and physical interface board end 104, e.g., receptacle end, can mate with a first cable end 106, e.g., plug end. Similarly, a cable 107 can connect the first cable end 106 to a second cable end 108. The second cable end 108 can connect to a network device, e.g., a modem, a router, a video monitor, an audio device, a set-top-box, a storage device, etc. 110. The network device 110 can receive packet based communication signals from a network, e.g. the Internet 128.

The user equipment 100 includes a communication interface 112, system logic 114, and a user interface 118. The system logic 114 may include a combination of hardware, software, firmware, or other logic. The system logic 114 may be implemented, for example, in a system on a chip (SoC), application specific integrated circuit (ASIC), or other circuitry. The system logic 114 is part of the implementation of a desired functionality in the user equipment 100. In that regard, the system logic 114 may include logic that facilitates, as examples, running applications, accepting user inputs, saving and retrieving application data, establishing, maintaining, and terminating cellular phone calls, wireless network connections, Bluetooth connections, or other connections, and displaying relevant information on the user interface 118. The user interface 118 may include a graphical user interface, touch sensitive display, voice or facial recognition inputs, buttons, switches, and other user interface elements.

The communication interface 112 may include one or more transceivers. The transceivers may include modulation/demodulation circuitry, amplifiers, phase locked loops (PLLs), clock generators, analog to digital and digital to analog converters and/or other logic for transmitting and receiving through one or more antennas, or through a physical (e.g., wireline) medium. The transmitted and received signals may adhere to any of a diverse array of formats, protocols, modulations, frequency channels, bit rates, and encodings. The user equipment 100 can also include one or more processors 116 and a memory 120. The memory 120 can store instructions executable by the processors 116, e.g., for processing signals received via the cable 107. The communication interface 112 may also include encoder/decoder, e.g. to process packetized audio and video streams.

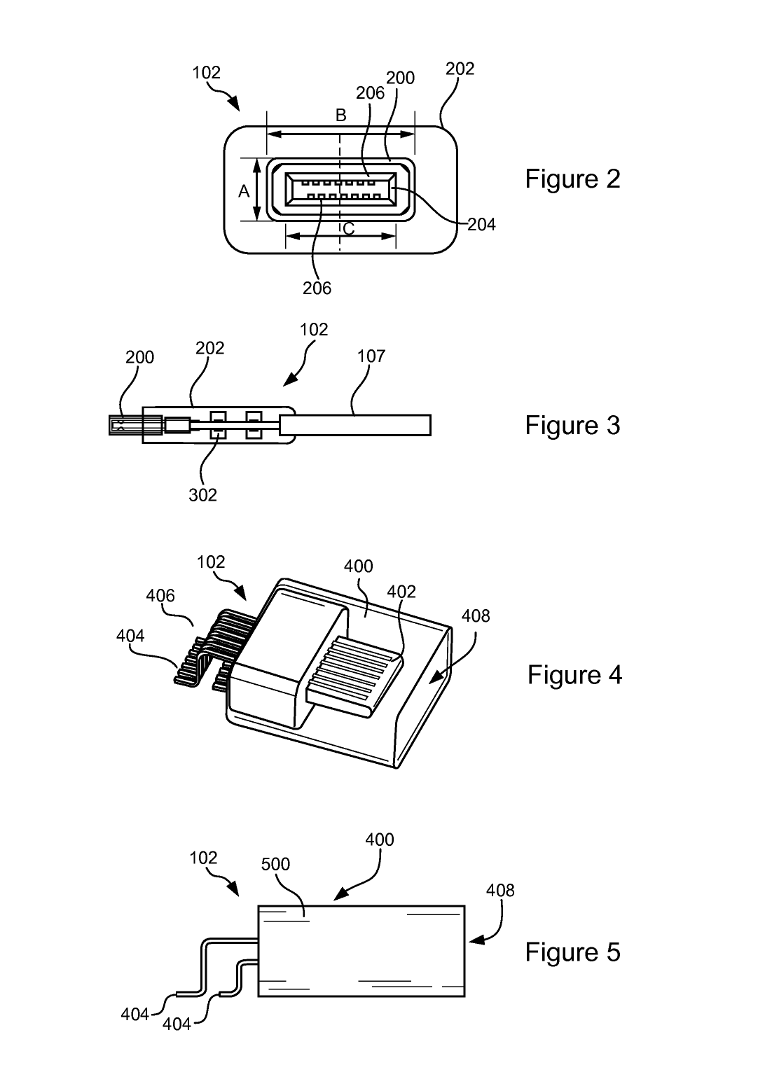

FIG. 2 is a front view of a plug end of the exemplary connector 102. The connector 102 includes a plug 200 and protective overmold 202. The plug 200 can be sized to fit various types of low profile user equipment 100 including tablets, ultra-notebooks and mobile phones, e.g., smartphones. In one example, the plug 200 is about 2.5 mm in the A direction and about 5.5 mm in the B direction, with an opening 204 of about 3.5 mm in the C direction. In FIG. 3, for example, the overmold 202 does not extend to the front end of the plug 200. To make an electrical connection with the user equipment 100, the plug 200 includes pins 206. The connector 102 can include 14 pins 206, for example, four pairs of pins to carry, e.g., packet based communication signals, and six pins for power and ground. The pins 206 can be arranged symmetrically so that the connector 102 can be plugged in either with a ‘top side’ facing either up or down. The pins 206 can be spaced in rows about 0.4 mm apart, and the rows of pins can offset from each other, for example by about 0.2 mm. Other amounts of pins and arrangements of the pins can also be used.

FIG. 3 is a side view of a plug end of the exemplary connector 102. The side view illustrates an exemplary relationship of the overmold 202 to the plug 200, e.g., the plug extends beyond the overmold 202, and the overmold 202 covers a portion of a sheathing of a cable, e.g., the cable 107. A way to lower the cost and complexity of the user equipment 100 is to provide for AC coupling instead of transformer coupling, but transformer coupling can be used in some implementations, e.g., described below. In some examples, to save space in the user equipment 100 no passive components are included. The AC coupling can include a transformer, e.g., autotransformer 302, in addition to AC coupling capacitors in the cable end 106.

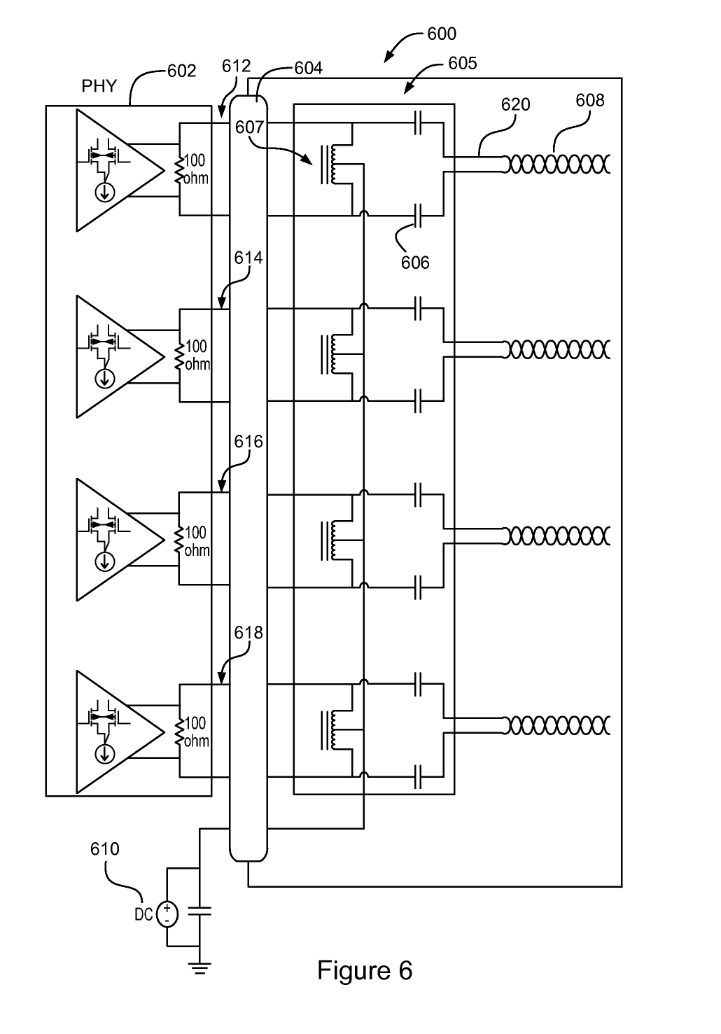

The cable 107 can include symmetrical or asymmetrical connections. In symmetrical cabling, the connector 102 can be included on both ends of the cable 107 to utilize AC coupling and signaling over a simplified cable assemble, such as discussed in the FIG. 6 example. The cabling can include passive components at one or both ends of the cable 107, e.g. capacitors and common modes chokes. A bandwidth, diameter and cost of the cable can be varied depending on an implementation. A low cost Gigabit Ethernet (GE) using full standards-based 1000BASE-T twisted pair signaling variant could be assembled with higher cost variants for the higher speed signaling available.

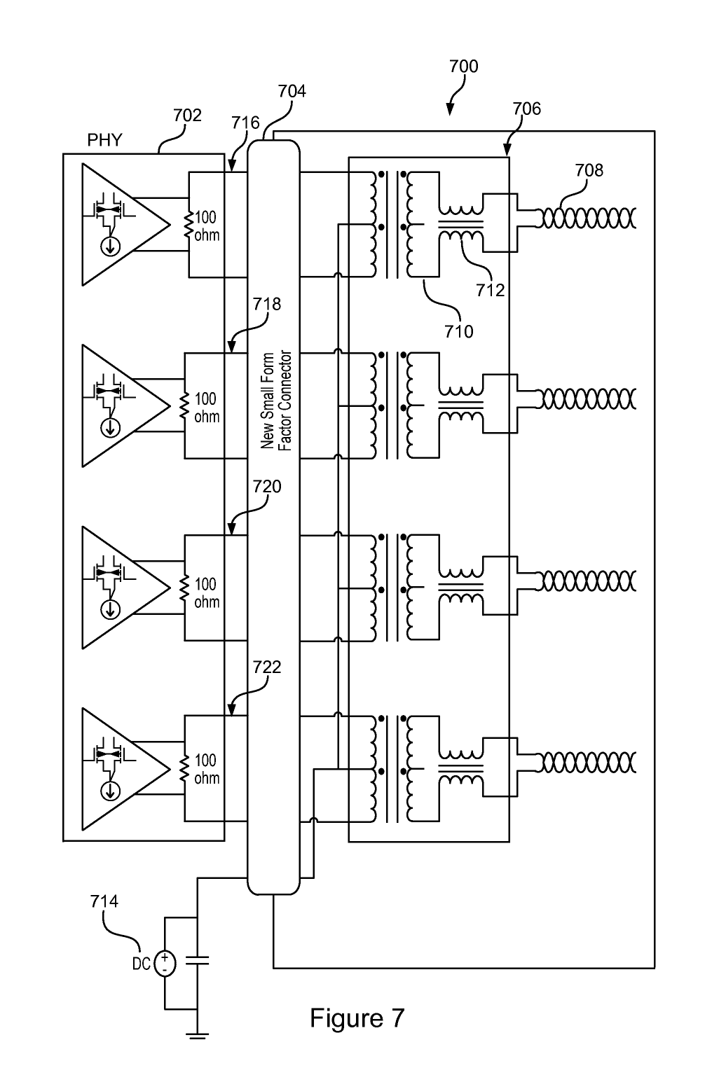

To connect to legacy equipment, such as home gateways, or to connect to enterprise infrastructure, such as an RJ45 jack in the wall, the cabling can include asymmetrical connections, e.g., the connector 102 positioned on one end and RJ45 on the other. When connected to existing equipment the board end 104 typically does not include a transformer. Therefore, when connecting to an RJ45 connector the cable end 106 can include the transformer, e.g., as shown in FIG. 7. The channel characteristics of the asymmetrical cable can include the characteristics of the corresponding BASE-T standard, or as close as possible, e.g., Cat5e for 1000BASE-T, Cat6a for 10GBASE-T. Having the option to use the asymmetrical cabling can provide backward compatibility to existing infrastructures.

FIG. 4 is a perspective view and FIG. 5 is a side view of an exemplary receptacle end 400 of the connector 102. The receptacle end 400 can be installed with the user equipment 100. The receptacle end 400 includes terminals 402 to mate with the pins 206 of the plug 200. For impedance control, termination 404 of the terminals 402 can be mounted to a surface 406 or a through hole in the surface 406 of the user equipment 100 to provide. A shield 500, e.g., metal, can cover the terminals 402. The shield 500 includes an opening 408 to receive the plug 200.

FIG. 6 is a circuit diagram of the connector 102 using exemplary AC coupling. The connector components 600 include a PHY 602, a connector interface 604, passive circuitry 605 and cabling 608, e.g., shielded cable. The PHY 602 can be implemented with a conventional BASE-T PHY, like 1000BASE-T, also known as GE, or 10GBASE-T. The passive circuitry 605 can include AC coupling capacitors 606 and autotransformers 607. The passive circuitry 605 can be contained in the overmold 202 of cable end 106 of the connector 102. Therefore, passive circuitry need not be located in the user equipment 100 to save space in the user equipment 100. The cabling 608 can include twisted pair type cabling or other cabling, such as twinax, co-axial and optical. A power source 610 including direct current (DC) power supply and a capacitor connected to ground can power the passive components 606. A first cable 612, a second cable 614, a third cable 616 and a fourth cable 618 can connect between the PHY 602 and the passive circuitry 605. The signals can be sent simultaneously and bi-directionally.

FIG. 7 is a circuit diagram of the connector 102 using exemplary transformer coupling. The transformer can be used, for example, in accordance with IEEE 802.3, when one end of the cable includes an RJ45 connector. The connector components 700 include a PHY 702, e.g., a conventional BASE-T PHY, like 1000BASE-T, also known as GE, or 10GBASE-T, a connector interface 704, passive components 706 and cabling 708. The passive components 706 can include a transformer 710 and a common mode choke 712. The passive components 706 can be contained in the overmold 202 of the connector 102, and do not have to be located in the user equipment 100. The cabling can include twisted pair type cabling or other cabling, such as twinax, co-axial or optical.

A power source 714 including direct current (DC) power supply and a capacitor connected to ground can power the passive components 706, e.g., via connector interface 704. A first cable 716, a second cable 718, a third cable 720 and a fourth cable 722 can connect between the PHY 702 and the passive components 706.

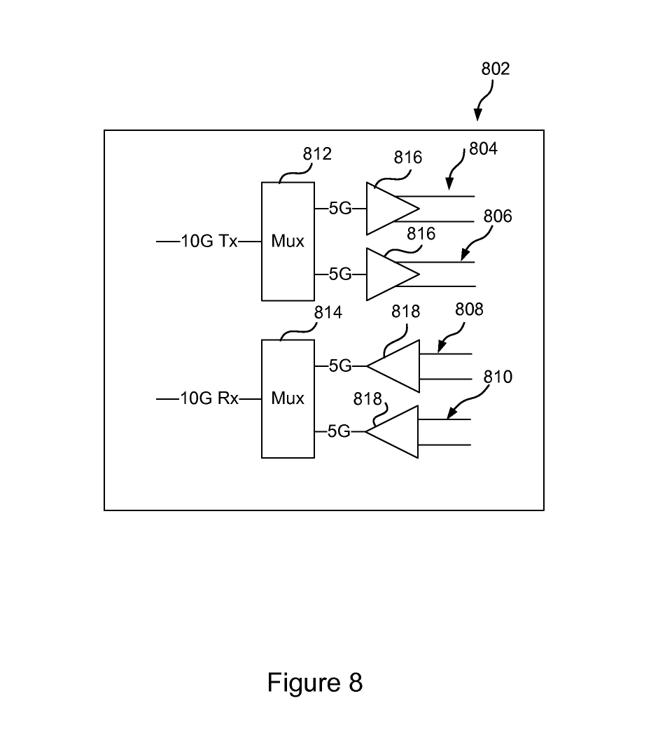

FIG. 8 is a circuit diagram of an exemplary PHY 802 for a new 100 protocol. New 100 protocols can be developed to minimize implementation complexity and cost, while minimizing the bandwidth of a connection of the connector 102. The new 100 protocol can utilize cabling of individually shielded pairs of cables, and other types of cables may also be used. A PHY 802 of the new 10 G protocol can connect to, e.g., four pairs of twisted pair wires, a first pair 804, a second pair 806, a third pair 808 and a fourth pair 810, for conducting the signaling. Other numbers of cabling can also be used. In one example, the next generation 100 protocol can be enabled for short, point to point links. This can remove constraints of the BASE-T standards that work up to 100 m based twisted pair structured cabling. The new 10 G protocol can include the MAC interface as well as 10GBASE-T.

The signaling of the new 100 protocol can separate transmit and receive signaling over the four twisted pairs of wires 804, 806, 808 and 810. For example, the new 100 protocol can transmit data over two pair mediums 804, 806, e.g., at 5 Gb/s per pair, to spread the work over the available mediums. The new 10 G data can also be received over two twisted pair mediums 808, 810, e.g., 5 Gb/s per pair. An exemplary 10 G protocol is described for purposes of explanation. A data rate per pair, however, need not be 100. Higher or lower data rates can also be accommodated. Additionally, the new 100 or other rate protocol can use two pair transmit/two pair receive, or the protocol can implement one pair each direction, for lower data rate. Also, the rate in each direction can vary and need not be equal.

The PHY 802 can include integrated circuitry, e.g., a transmit multiplexer 812 and a receive multiplexer 814, and a transmit signaler/driver 816 and a receive signaler/receiver 818 including logic. The multiplexers 812, 814, transmit/receive drivers 816, 818, and logic can control the transmission and receiving of 10 G signaling, for example, over two pairs of transmit cabling and two pairs of receiving cabling, so that only about 5 Gb/s of data bandwidth is needed per pair of wires, allowing for a less expensive and more flexible and durable cabling to be used. Other numbers of twisted pairs can be used as well as other speeds. Therefore, the signaling bandwidth can be spread over numbers of twisted pair accordingly.

Coding of the logic can range from non-return-to-zero (NRZ), similar to that used with 10GBASE-R which is the coding used with SFP+ at 10.3125Gb/s, to a complex multilevel code as complex as used in 10GBASE-T, e.g., at 5 Gb/s per pair. The more complex the code the more cabling bandwidth requirements can be reduced by increasing the bits per symbol. The choice of coding can depend on trading off coding implementation complexity and cost versus cabling complexity and cost. In some implementations the cost and durability of the cabling can be controlled by limiting a length of the cable to about 2 meters or less. The connector 102 can provide magnetic coupling and/or AC coupling so that the user equipment 100 need not contain it.

Referring to FIGS. 1-8, the connector 102 can be used with various types of signaling depending on an implementation. Additionally or alternatively, the system, e.g., as in FIG. 1, using the connector 102, e.g., with passive components in the cable end 106, can use auto-negotiation to discover and configure the connection, e.g., by choosing common transmission parameters, such as speed, duplex mode, and flow control to connect devices. The connected devices can share their capabilities regarding these parameters and then choose the highest performance transmission mode that they both support. In the open systems interconnection (OSI) model, auto-negotiation can reside in the PHY layer, e.g., 602, 702, 802. For Ethernet over twisted pair the auto-negotiation can occur according to clause 28 of IEEE 802.3.

The 1000BASE-T standard can be a deployed wired connection for gigabit speeds using existing signaling, while taking advantage of the AC coupling and/or transformer coupling, and small form factor of the connector 102. Similarly, current protocols based on 10GBASE-T can utilize the small form factor and AC coupling and/or transformer coupling, of the connector 102. The connector 102 can also be used with the new 10 G protocols.

The connector 102 can be coupled to connectors 108 of a variety of standards and protocols, e.g., in addition to IEEE 802.3. For example, the connector 102 can connect via cable 107 to other connector types 108 including a high definition multimedia interface (HDMI or equivalent), a docking station interface, e.g., having no cabling but back-to-back connectors, storage, USB and display interface. For example, packetized HDMI and native HDMI can be sent over cable 107 to the communication interface 112 of the user equipment 100. Additionally or alternatively, USB signaling can be sent over cable 107 to communication interface 112.

The system logic 114 and/or communication interface 112 can detect a type of connection being made by the link partner, e.g., USB, HDMI, display interface, and configure a protocol of the user equipment 100 accordingly. For example, if the user equipment is connected to a USB at the link partner, the user interface 112/electrical and physical interface board end 104 can become a USB port. The same can apply for HDMI, display interface and other variants. The connector 102 can provide for at least two of HDMI, USB, Ethernet and display interface protocols.

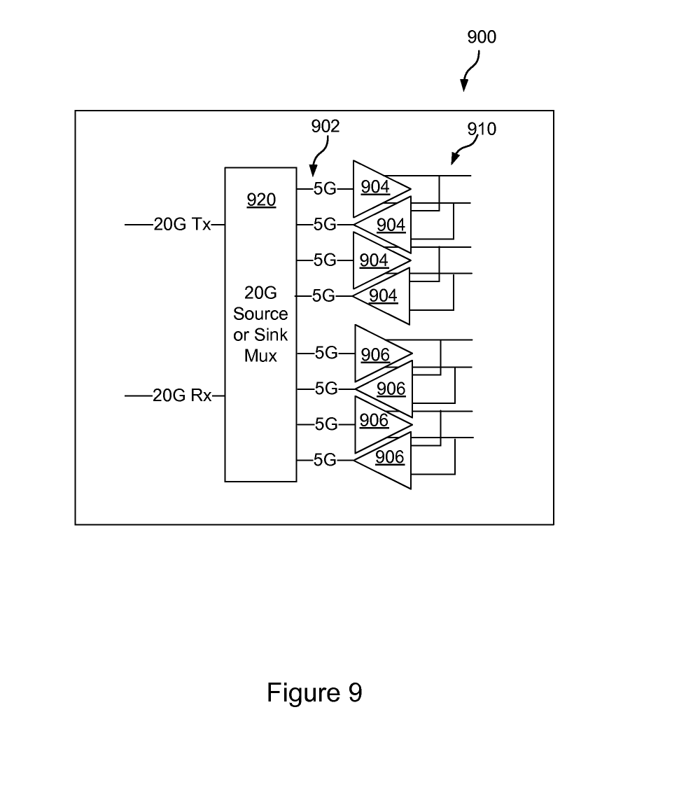

FIG. 9 is a circuit diagram of an exemplary PHY 900 for a display interface, e.g., DisplayPort. DisplayPort utilizes a net data rate of 4.32 Gb/s×4=17.28 Gb/s. HDMI data is also transferred on multiple lanes of medium. For packetized data transfer, the PHY 900 can include multiple lanes 902 at 5 Gb/s. Since video includes two types, source and sink, the PHY 900 can include four drivers 904 for Tx and four drivers 906 for Rx. Each twisted pair 910 can include one for Tx and one Rx, connected together. The 5 Gb/s links 902 can remain simplex, with the connection being either as source or sink, but not the same at the same time. The links 902 connect with a source/sink multiplexer 920 to provide a total bandwidth of 4×5 Gb/s or 20 Gb/s.

A balance of the bandwidth can be available for packetized data, which can be available as Ethernet. Therefore, an ‘out of band’ data path can be available for data transfer on the video link. The Ethernet data can be bi-directional. The link can be simplex with no echo cancellation. However, time division multiplexing can be used. A 5 Gb/s pair is determined as transmitting in one direction from link partner A, with the Rx on link partner B. The Tx from A to B can be gated off, and the link can transmit in the opposite direction, from B to A. Therefore, the 5 Gb/s link can be determined as simplex but the bandwidth can be dynamically allocated as occurring in either direction, A to B, or B to A.

While various embodiments of the have been described, many more embodiments and implementations are possible. Accordingly, the embodiments are not to be restricted.

What is claimed is:

1. A connector, comprising:
a connector interface;
a cable housing covering the connector interface and a cable connected with the connector interface; and
a passive component positioned within the cable housing, the passive component connected with the connector interface and the cable.

2. The connector of claim 1 where the cable includes a twisted pair cable, where the twisted pair cable comprises four pairs of twisted pair cable for signaling, two pair for transmitting signals and two pair for receiving signals.

3. The connector of claim 1 where the passive components comprises an autotransformer.

4. The connector of claim 3 where the passive components further comprises an AC coupler.

5. The connector of claim 3 where the passive components further comprises a transformer.

6. The connector of claim 1 where the connector interface provides for at least two of HDMI, USB, Ethernet and display interface protocols.

7. The connector of claim 1 where the connector interface is sized to fit low profile user equipment for providing Ethernet to the user equipment.

8. The connector of claim 1 further including a PHY positioned within the cable housing.

9. The connector of claim 8 where the PHY performs auto-negotiation to discover and configure the connection.

10. An Ethernet connector, comprising:
a connector interface; and
four cables connected to the connector interface, two cables for transmitting signals and two cables for receiving signals.

11. The Ethernet connector of claim 10 further comprising a cable housing covering the connector interface and the four cables and passive components positioned within the cable housing, the passive components connected with the four cables.

12. The Ethernet connector of claim 11 where the connector interface provides for at least two of HDMI, USB, Ethernet and display interface protocols.

13. The Ethernet connector of claim 11 where the passive components comprises an AC coupler.

14. The Ethernet connector of claim 11 where the passive components comprises a transformer.

15. The connector of claim 11 further including a PHY positioned within the cable housing.

16. The connector of claim 11 where the PHY performs auto-negotiation to discover and configure the connection.

17. A cabling, comprising:
a cable including at least one of a twisted pair, co-ax, or fiber optic;
a connector interface connected to one end of the cable, the connector interface sized to fit a mobile phone for providing at least one of HDMI, USB, Ethernet and display interface to the mobile phone; and
an HDMI, USB, RJ45 or DiplayPort connector connected to a second end of the cable.

18. The cabling of claim 17 further comprising a cable housing covering the connector interface and the cable, a passive component positioned within the cable housing, the passive component connected with the connector interface and the cable.

19. The cabling of claim 18 where the connector interface provides for at least two of HDMI, USB, Ethernet and display interface protocols.

20. The cabling of claim 18 where connector interface includes a simplex link but bandwidth is dynamically allocated in two directions.
